(19) United States
(12) Patent Application Publication
(10) Pub. No.: US 2006/0033287 A1
(43) Pub. Date: Feb. 16, 2006

(54) Controlled gap carbon seal

(76) Inventor: Giuseppe Rago, Mississauga (CA)

Correspondence Address: OGILVY RENAULT LLP (PWC), 1981 MCGILL COLLEGE AVENUE, SUITE 1600, MONTREAL, QC, H3A 2Y3, CA

(21) Appl. No.: 10/915,392

(22) Filed: Aug. 11, 2004

(51) Int. Cl. F16J 15/44

(52) U.S. Cl. 277/411

(57) ABSTRACT

At least one annular tooth is defined in at least one of an inner circumferential surface of a controlled carbon seal and an outer surface of a rotatable shaft. The annular tooth is axially disposed between the upstream and downstream radially extending faces, in opposing relation to the other of the inner circumferential surface of the carbon seal and the outer shaft surface, such that the annular tooth extends theretowards.

### TECHNICAL FIELD

The invention relates generally to seals for rotating shafts and, more particularly, to an improved controlled gap carbon seal.

### BACKGROUND OF THE ART

Controlled gap carbon seals are widely used to provide fluid seals around rotating shafts, particularly for high temperature environments such as in gas turbine engines. Controlled gap carbon seals provide relatively good sealing capabilities due to the relatively small clearances which can be maintained between the carbon ring seal and an inner runner, such as a rotating shaft of a gas turbine engine for example. Such tight shaft clearances are possible due to the ability of the carbon ring seal to radially “float” relatively to the rotating shaft, which eliminates any possible eccentricity of the rotating shaft. Such carbon seals also typically include an outer shrink band, within which the carbon ring is disposed, provided to control the thermal growth of the carbon ring.

However, controlled gap carbon seals generally provide less effective sealing than multiple-tooth labyrinth seals, which are also commonly employed for sealing rotating shafts in gas turbine engines. As an example, the gas flow through a clearance gap between a controlled gap carbon seal is roughly equivalent to the flow through a single-toothed labyrinth seal running at the same clearance. Such multiple-tooth labyrinth seals, conversely, are more affected by shaft eccentricities and thermal expansion, and are therefore less effective at maintaining a small gap between the shaft and the seal.

Accordingly, an improved shaft seal is sought.

### SUMMARY OF THE INVENTION

It is therefore an object of this invention to provide an improved controlled gap carbon seal.

In one aspect, the present invention provides a controlled gap carbon seal assembly comprising: a rotatable shaft having a circumferential outer shaft surface and a longitudinal axis of rotation; an annular carbon seal mounted about the shaft for radial displacement such that a radial gap between the outer shaft surface and an inner circumferential surface of the carbon seal is controlled, the carbon seal having upstream and downstream radially extending faces axially spaced apart from each other; and at least one annular tooth defined in at least one of the inner circumferential surface of the carbon seal and the outer shaft surface, the annular tooth being axially disposed between the upstream and downstream radially extending faces, in opposing relation to the other of the inner circumferential surface of the carbon seal and the outer shaft surface such that the annular tooth extends theretowards.

In a second aspect, the present invention provides a controlled gap carbon seal adapted for sealing a rotatable shaft having an outer shaft surface and a longitudinal axis of rotation, the controlled gap carbon seal comprising: an annular carbon seal mounted about the shaft for radial displacement such that a radial gap between the outer shaft surface and an inner circumferential surface of the carbon seal is controlled, the carbon seal having upstream and downstream radially extending faces axially spaced apart from each other to define an axial depth of the carbon seal, the inner circumferential surface of the carbon seal defining a land area having an axial land distance less than the axial depth of the carbon seal; and at least one annular tooth defined in the carbon seal axially spaced apart from the land area, the annular tooth being opposed to the outer shaft surface and extending theretowards.

In a third aspect, the present invention provides a controlled gap carbon seal adapted for sealing a rotatable shaft having a circumferential outer shaft surface and a longitudinal axis of rotation, the controlled gap carbon seal comprising: an annular carbon seal adapted for mounting about the shaft such that radial displacement thereof maintains a controlled radial gap between the outer shaft surface and an inner circumferential surface of the carbon seal, the carbon seal having upstream and downstream radially extending faces axially spaced apart from each other; and at least one annular tooth defined in the inner circumferential surface of the carbon seal, the annular tooth being axially disposed between the upstream and downstream radially extending faces, the annular tooth extending radially inward from the carbon seal towards the outer shaft surface.

In a fourth aspect, the present invention provides a controlled gap carbon seal adapted for sealing a rotatable shaft having a circumferential outer shaft surface and a longitudinal axis of rotation, the controlled gap carbon seal comprising: an annular carbon seal disposed within a housing adapted for stationary mounting about the shaft such that a controlled radial gap between the outer shaft surface and an internal circumferential surface of the carbon seal is provided, the carbon seal having upstream and downstream radially extending faces axially spaced apart from each other, the carbon seal being constrained for movement in a radial direction within the houseing as necessary to maintain the radial gap; a shrink band having a thermal expansion coefficient different from that of the carbon seal and engaged about an outer circumferential surface thereof, the shrink band maintaining the carbon seal in compression therewithin; and at least one annular tooth defined in the internal cicumferential surface of the carbon seal and being axially disposed between the upstream and downstream radially extending faces thereof, the annular tooth opposing the outer shaft surface when the controlled gap carbon seal is disposed in place around the shaft.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a schematic cross-sectional view of a gas turbine engine;

FIG. 2 is a partial cross-sectional view of a typical controlled gap carbon seal of the prior art;

FIG. 3 is a partial cross-sectional view of a controlled gap carbon seal in accordance with a first embodiment of the present invention; and

FIG. 4 is a partial cross-sectional view of a controlled gap carbon seal in accordance with a second embodiment of the present invention.

### DETAILED DESCRIPTION OF THE PREFERRED EMBODIMENTS

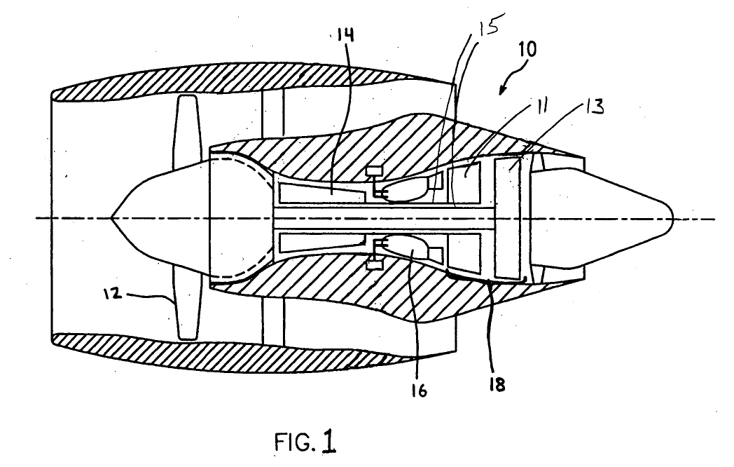

FIG. 1 illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases.

The high pressure turbine 11 and the low pressure turbine 13 of the turbine section 18 are each respectively linked to the compressor 14 and the fan 12 by a main engine shaft 15, the two main engine shafts being concentric within one another. Seals are provided about these rotating main engine shafts 15 at various locations throughout the gas turbine engine to ensure that the compressed air and/or combustion gases are maintained in the main gas flow path, and that secondary cooling air or lubrication oil is retained in the respective flow passages on the opposed side of the seals.

The present invention provides one such shaft seal, namely a controlled gap carbon seal, which while described herein with reference to gas turbine engine shafts, is also applicable to any other fluid sealing arrangement about a rotating shaft. For example only, high speed pumps and compressors used in high temperature and/or severe service conditions represent other applications in which the present rotating shaft seal may prove viable. As noted above, controlled gap carbon seals provide relatively good sealing capabilities about such rotating shafts due to the relatively small clearances which can be maintained between the carbon ring seal and an inner runner such as an outer surface of the rotating shaft of a gas turbine engine for example.

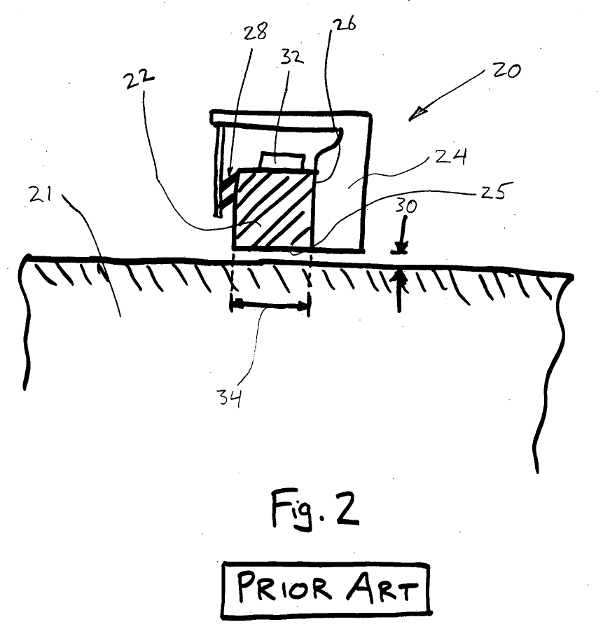

Referring to FIG. 2, a conventional controlled gap carbon seal 20 of the prior art which provides a seal about a rotating shaft 21, includes generally a carbon sealing ring 22 supported within a stationary housing 24. The internal circumferential surface 25 of the carbon ring 22 has an axial distance 34 which defines a land area sufficient to cause the free-floating carbon ring 22 to be radially displaced by fluid dynamic forces generated by gas passing through the annular gap 30, defined between an outer surface 23 of the rotating shaft 21 and the inner surface 25 of the carbon ring 22. The carbon ring 22 comprises a radially extending face 26 which abuts the housing 24, and is biased thereagainst by a biasing member 28 such as a spring. The carbon ring 22 is therefore radially displaceable, ie: it can radially “float”, such that a relatively narrow annular gap 30 can be maintained. Thus, eccentricity in the shaft can be accommodated without causing undue loss of sealing capabilities. An outer shrink band 32, which is preferably metallic, is also provided about the carbon ring 22 to control the thermal growth of the carbon ring, thus maintaining a relatively constant gap 30 throughout the operating temperature range of the system.

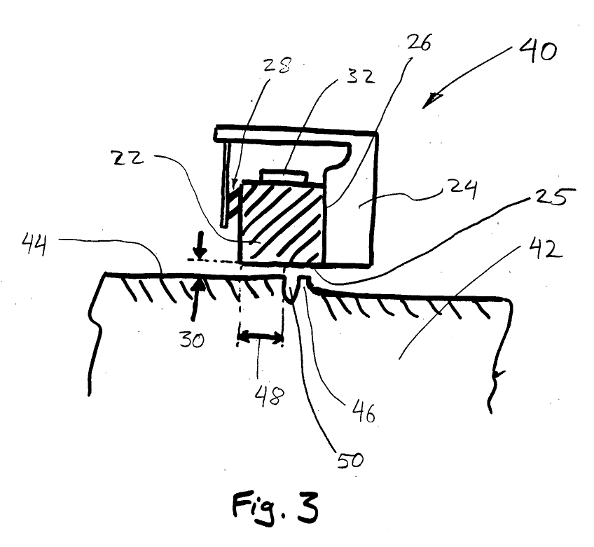

Referring now FIG. 3, a first embodiment of the controlled gap carbon seal assembly 40 of the present invention similarly comprises a carbon ring 22 supported within the stationary housing 24 and having a shrink band 32 disposed radially outward therefrom for controlling the thermal growth of the carbon ring 22. The shrink band 32 has a thermal expansion coefficient different from that of the carbon sealing ring and is engaged about an outer annular surface thereof. Preferably, the shrink ring 32 is metallic and has a thermal expansion coefficient substantially similar to that of the shaft. The shrink band 32 is shrunk in place about the carbon ring, thereby maintaining the carbon sealing ring in compression therewithin. Accordingly, as the shaft heats up and expands during operation, the shrink band 32 preferably expands at much the same rate, permitting the pre-compressed carbon ring to expand, by returning to its uncompressed state as well as due to thermal expansion. Thus, the rate of expansion of the carbon ring become greater than its inherent. thermal rate of expansion, ensuring that the radial gap between the carbon ring and the shaft is maintained substantially constant throughout a large temperature range.

A biasing member 28 acts a radially extending surface 26 of the carbon ring 22 against the stationary housing 24, thereby constraining the otherwise free-floating carbon ring 22 to radial movement such that the necessary annular gap 30 is maintained between the rotating shaft and the carbon seal. In the present invention, however, the controlled gap carbon seal assembly 40 makes additional use of the benefit of a labyrinth seal by integrating at least one tooth of such a labyrinth seal into a controlled gap carbon seal. Particularly, in the embodiment of FIG. 3, the shaft 42 of the seal assembly 40 comprises a running surface portion 44 which defines the axial land distance 48 with the internal circumferential surface 25 of the carbon seal 22. The shaft 42 also comprises a discontinuous projection 46 in the form of an annular tooth which is axially spaced apart from the smooth running surface portion 44 by an annular groove 50 defined in the shaft. The annular tooth 46 is preferably integrally formed in the shaft and defines a labyrinth seal-type tooth in opposed relation to the internal circumferential surface 25 of the carbon seal 22. The land area defined by the axial land distance 48 is sufficient to abut the seal if necessary and to provide the fluid dynamic driven radial floating action of the carbon seal ring 22. The annular tooth 46 defined in the shaft 42 thus provides the sealing advantages of a labyrinth seal to the controlled gap carbon seal assembly 40, by effectively reducing the airflow possible through the gap 30 by approximately 30% in comparison with the standard controlled gap carbon seal 20 of the prior art. While a single tooth projection 46 is depicted in FIG. 3, it is to be understood that additional teeth projections can be added, whether to the shaft or to the carbon seal. The use of two such teeth further reduces the airflow possible through the gap 30, particularly by approximately 40% relative to the standard controlled gap carbon seal 20 of the prior art. Therefore, the controlled gap carbon seal assembly 40 of the present invention combines the advantages of a controlled gap carbon seal, namely the ability to accommodate any eccentricities of the rotating shaft while maintaining a close gap clearance therewith, with those of a labyrinth seal, namely the flow impedance characteristics.

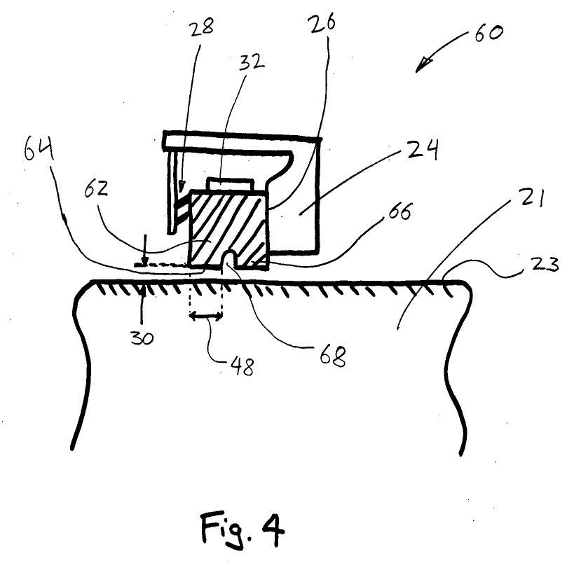

Referring now to a second embodiment of the present invention as depicted in FIG. 4, in which the labyrinth tooth projection is provided in the carbon seal ring itself, rather than in the adjacent shaft. The controlled gap carbon seal assembly 40 comprises a carbon sealing ring 62 that is disposed within the stationary housing 24 and has a radially extending surface 26 which is axially biased into engagement with the housing 24 by a biasing member 28, while remaining displaceable in the radial direction as necessary to maintain a controlled gap 30 between an internal circumferential runner surface 64 of the carbon seal ring 62 and the outer surface 23 of the rotating shaft 21. A shrink band 32 is also provided to control the thermal growth of the carbon seal ring 62 such that the gap 30 is maintained throughout the temperature operating range of the seal assembly.

The internal circumferential surface 64 of the carbon seal ring 62 is interrupted by an annular tooth projection 66, preferably integrally formed therein and defined by an annular groove 68 formed in the carbon seal ring 62 immediately adjacent thereto. Thus the annular groove 68 axially spaces the annular tooth 66 apart from a first land area of the inner circumferential running surface 64. In the embodiment shown, the annular groove 68 is provided approximately midpoint along the axial length of the inner circumferential surface 64 of the carbon seal ring, thus effectively dividing the inner circumferential surface 64 of the carbon seal ring 62 into two projecting teeth portions, each one disposed on one side of the annular groove. The first land area of the internal circumferential surface 64 of the carbon seal ring 62 defined by the axial land distance 48, remains sufficient to abut the seal if necessary and to provide the fluid dynamic driven radial floating action of the carbon seal ring 62. The annular tooth projection 66 itself defines a second land area of the internal circumferential surface 64disposed on the opposite side of the annular groove 68, and having a second axial land distance 49. Preferably, the second axial land distance 49 is approximately the same size as the first axial land distance 48. Although the annular groove 68 depicted in FIG. 4 is located near an axial midpoint of the carbon seal ring, it is to be understood that the annular groove may also be located closer to an axial end of the carbon seal, thus creating a difference between the first axial land distance 48 and the second axial land distance 49. As in the controlled gap carbon seal assembly 20, the annular tooth 66 acts like a tooth of a labyrinth seal, providing additional sealing capability to the controlled gap carbon seal assembly 60, effectively reducing the airflow through the gap 30 by approximately 30% in comparison with the standard controlled gap carbon seal 20 of the prior art. Although not depicted, the inner circumferential surface of the carbon seal may be provided with at least a first annular tooth and the opposing outer shaft surface with at least a second annular tooth which is axially offset from the first.

While labyrinth teeth having different radial length are possible, the labyrinth tooth projections 46 and 66 preferably do not radially project beyond the integral runner surfaces 44 and 64 of the shaft 42 and the carbon seal ring 62 respectively. Thus, the controlled radial gap 30 is maintained between the inner circumferential surface of the carbon seal ring and the outer surface of the rotating shaft.

Therefore, the addition of at least one labyrinth seal-type annular tooth integrally formed in either the carbon seal ring or the shaft itself, provides significantly improved air flow reduction through the gap 30 of the controlled gap carbon seal assemblies of the present invention. This eliminates the need for two separate seals, namely independent labyrinth and controlled gap carbon seals, in order to adequately seal a rotating shaft. Thus, a single controlled gap carbon seal assembly 40, 60 which space and cost efficient may be used to effectively seal a high speed rotating shaft which may operate under severe service conditions such as those having high operating temperatures.

The above description is meant to be exemplary only, and one skilled in the art will recognize that changes may be made to the embodiments described without department from the scope of the invention disclosed. For example, although the sealing rings 22,62 of the present seal assemblies is described herein as a carbon seal, it is to be understood that the sealing ring may be made of other materials capable of adequately providing the sealing capabilities required while withstanding the temperature and frictional requirements necessary for sealing high speed rotating shafts. Further a plurality of annular teeth may be provided in either the carbon seal and/or the shaft itself. It will be appreciated by one skilled in the art that the number of teeth will be chosen with consideration to the dimensional constraints of the carbon seal assembly, and the need to provide at least a predetermined land area on the inner circumferential surface of the carbon seal such that fluid dynamic forces are able to adequately cause the “floating” carbon seal ring to be radially displaced as required to control the radial gap between the shaft and the carbon seal. Still other modifications which fall within the scope of the present invention will be apparent to those skilled in the art, in light of a review of this disclosure, and such modifications are intended to fall within the appended claims.

1. A controlled gap carbon seal assembly comprising:
a rotatable shaft having a circumferential outer shaft surface and a longitudinal axis of rotation;
an annular carbon seal mounted about the shaft for radial displacement such that a radial gap between the outer shaft surface and an inner circumferential surface of the carbon seal is controlled, the carbon seal having upstream and downstream radially extending faces axially spaced apart from each other; and
at least one annular tooth defined in at least one of the inner circumferential surface of the carbon seal and the outer shaft surface, the annular tooth being axially disposed between the upstream and downstream radially extending faces, in opposing relation to the other of the inner circumferential surface of the carbon seal and the outer shaft surface such that the annular tooth extends theretowards.

2. The controlled gap carbon seal assembly as defined in claim 1, wherein a radial distance between a tip of the annular tooth and the other of the inner circumferential surface of the carbon seal and the outer shaft surface corresponds to the radial gap.

3. The controlled gap carbon seal assembly as defined in claim 1, wherein at least two annular teeth are defined in the at least one of the inner circumferential surface of the carbon seal and the outer shaft surface.

4. The controlled gap carbon seal assembly as defined in claim 1, wherein at least a first annular tooth is defined in the inner circumferential surface of the carbon seal, and at least a second annular tooth is defined in the outer shaft surface axially offset from the first annular tooth.

5. The controlled gap carbon seal assembly as defined in claim 1, wherein the annular tooth is integrally formed in the at least one of the inner circumferential surface of the carbon seal and the outer shaft surface.

6. The controlled gap carbon seal assembly as defined in claim 5, wherein the annular tooth is defined in the at least one of the inner circumferential surface of the carbon seal and the outer shaft surface by an annular groove formed therein immediately adjacent to the annular tooth.

7. A controlled gap carbon seal adapted for sealing a rotatable shaft having an outer shaft surface and a longitudinal axis of rotation, the controlled gap carbon seal comprising:
an annular carbon seal mounted about the shaft for radial displacement such that a radial gap between the outer shaft surface and an inner circumferential surface of the carbon seal is controlled, the carbon seal having upstream and downstream radially extending faces axially spaced apart from each other to define an axial depth of the carbon seal, the inner circumferential surface of the carbon seal defining a land area having an axial land distance less than the axial depth of the carbon seal; and
at least one annular tooth defined in the carbon seal axially spaced apart from the land area, the annular tooth being opposed to the outer shaft surface and extending theretowards.

8. The controlled gap carbon seal as defined in claim 7, wherein a radial distance between a tip of the annular tooth and the outer shaft surface corresponds to the radial gap.

9. The controlled gap carbon seal as defined in claim 7, wherein at least two annular teeth are defined in the carbon seal.

10. The controlled gap carbon seal as defined in claim 7, wherein the annular tooth is integrally formed in the carbon seal.

11. The controlled gap carbon seal as defined in claim 10, wherein the annular tooth is defined in the carbon seal by an annular groove formed therein immediately adjacent to the annular tooth.

12. A controlled gap carbon seal adapted for sealing a rotatable shaft having a circumferential outer shaft surface and a longitudinal axis of rotation, the controlled gap carbon seal comprising:
an annular carbon seal adapted for mounting about the shaft such that radial displacement thereof maintains a controlled radial gap between the outer shaft surface and an inner circumferential surface of the carbon seal, the carbon seal having upstream and downstream radially extending faces axially spaced apart from each other; and
at least one annular tooth defined in the inner circumferential surface of the carbon seal, the annular tooth being axially disposed between the upstream and downstream radially extending faces, the annular tooth extending radially inward from the carbon seal towards the outer shaft surface.

13. The controlled gap carbon seal as defined in claim 12, wherein a radial distance between a tip of the annular tooth and the outer shaft surface corresponds to the radial gap.

14. The controlled gap carbon seal as defined in claim 12, wherein at least two annular teeth are defined in inner circumferential surface of the carbon seal.

15. The controlled gap carbon seal as defined in claim 12, wherein the annular tooth is integrally formed in the carbon seal.

16. The controlled gap carbon seal as defined in claim 15, wherein the annular tooth is defined in the carbon seal by an annular groove formed therein immediately adjacent to the annular tooth.

17. A controlled gap carbon seal adapted for sealing a rotatable shaft having a circumferential outer shaft surface and a longitudinal axis of rotation, the controlled gap carbon seal comprising:
an annular carbon seal disposed within a housing adapted for stationary mounting about the shaft such that a controlled radial gap between the outer shaft surface and an internal circumferential surface of the carbon seal is provided, the carbon seal having upstream and downstream radially extending faces axially spaced apart from each other, the carbon seal being constrained for movement in a radial direction within the housing as necessary to maintain the radial gap;
a shrink band having a thermal expansion coefficient different from that of the carbon seal and engaged about an outer circumferential surface thereof, the shrink band maintaining the carbon seal in compression therewithin; and
at least one annular tooth defined in the internal circumferential surface of the carbon seal and being axially disposed between the upstream and downstream radially extending faces thereof, the annular tooth opposing the outer shaft surface when the controlled gap carbon seal is disposed in place around the shaft.
